(19) United States
(12) Patent Application Publication
(10) Pub. No.: US 2009/0236369 A1
(43) Pub. Date: Sep. 24, 2009

(54) Container structure with dispensing valve

(76) Inventor: Hsueh-Chih Lin, Taichung County (TW)

Correspondence Address: Lin, Hsueh-Chih, P.O. Box 44-2049, Taipei, 10668, TW

(21) Appl. No.: 12/076,558

(22) Filed: Mar. 20, 2008

(51) Int. Cl. B67D 5/06

(52) U.S. Cl. 222/185.1

(57) ABSTRACT

The invention relates to a container structure with a dispensing valve capable of completely draining tea or drink contained therein without the tea or drink being wasted. The container structure is made of a metal material, which is circled to form a cylindrical sidewall. A baseplate is tightly joined to a bottom end of the sidewall. The baseplate crosses two opposite sides of the sidewall and gradually tilts. The dispensing valve corresponding to a lowest portion of the container structure and the inclined baseplate is mounted to the sidewall. When the container structure is placed horizontally or slantingly, the liquid contained in the container structure can fully flow to the dispensing valve and be drained out.

### BACKGROUND OF THE INVENTION

(1) Field of the Invention

The invention relates to a container structure having a dispensing valve, and more particularly to a container structure, which has a dispensing valve and is configured so that liquid, such as tea or drink, contained in the container structure can be drained out when the container structure is placed either horizontally or slantingly.

(2) Description of the Prior Art

Currently, a container structure for containing liquid, such as tea or drink, has a dispensing valve for directly dispensing the tea or drink. As shown in FIG. 1, a conventional container structure for containing tea or drink is mainly made of a stainless steel cylinder to form a container body 91. The bottom end of the container body 91 is joined to a baseplate 92 so that a chamber 93 for containing the liquid is formed between the container body 91 and the baseplate 92. The top opening of the container body 91 is joined to an upper cover 94 to prevent foreign objects or dust from entering the chamber 93. A dispensing valve 95 penetrates through a portion of the container body 91 close to the baseplate 92, and the dispensing valve may be opened or closed to control the provision of the liquid, such as the tea or drink.

When the dispensing valve 95 is mounted to the conventional structure, the dispensing valve 95 has to be higher than the baseplate 92 by a predetermined height so that the dispensing valve 95 can be fixed to the container body 91. Consequently, the baseplate 92 and the dispensing valve 95 cannot be too close to each other, and the liquid, such as the tea or drink, tends to be remained in the container body 91 between the baseplate 92 and the dispensing valve 95. Thus, the tea or drink is wasted, and it is complicated to treat the remained tea or drink.

Consequently, the baseplate of the conventional container structure still has to be improved.

### SUMMARY OF THE INVENTION

It is therefore an object of the invention to provide a container structure with a dispensing valve in order to decrease the remained and wasted liquid, such as tea or drink, greatly.

To achieve the above-identified object, the invention provides a container structure including a container body and a dispensing valve. The container body has a bottom end tightly joined to a baseplate to form a chamber. An inclined guiding portion is formed at a local position corresponding to a sidewall of the container body and an outer edge of the baseplate, and the inclined guiding portion is located at a lowest point of the chamber. The dispensing valve communicates with the inclined guiding portion and penetrates through the sidewall of the container body at a position corresponding to the inclined guiding portion. Thus, the liquid in this container body may fully flow to the dispensing valve along the inclined baseplate, and be fully drained out so that the liquid, such as tea or drink, contained in the container body cannot be partially hoarded and wasted.

The container structure with the dispensing valve according to the invention will become apparent from the following detailed description of the preferred but non-limiting embodiments. The following description is made with reference to the accompanying drawings.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a schematically partially pictorial view showing a conventional structure.

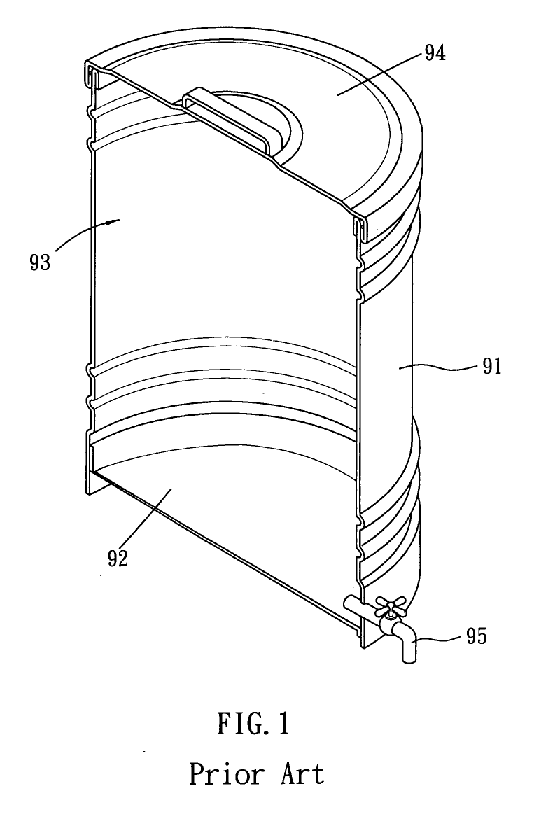

FIG. 2 is a schematically partially cross-sectional view showing the invention.

FIG. 3 is a schematic illustration showing a second embodiment of the invention.

FIG. 4 is a schematic illustration showing a third embodiment of the invention.

FIG. 5 is a schematic illustration showing a fourth embodiment of the invention.

FIG. 6 is a schematic illustration showing the implementation of the invention.

### DETAILED DESCRIPTION OF THE PREFERRED EMBODIMENTS

The present invention will be apparent from the following detailed description, which proceeds with reference to the accompanying drawings, wherein the same references relate to the same elements.

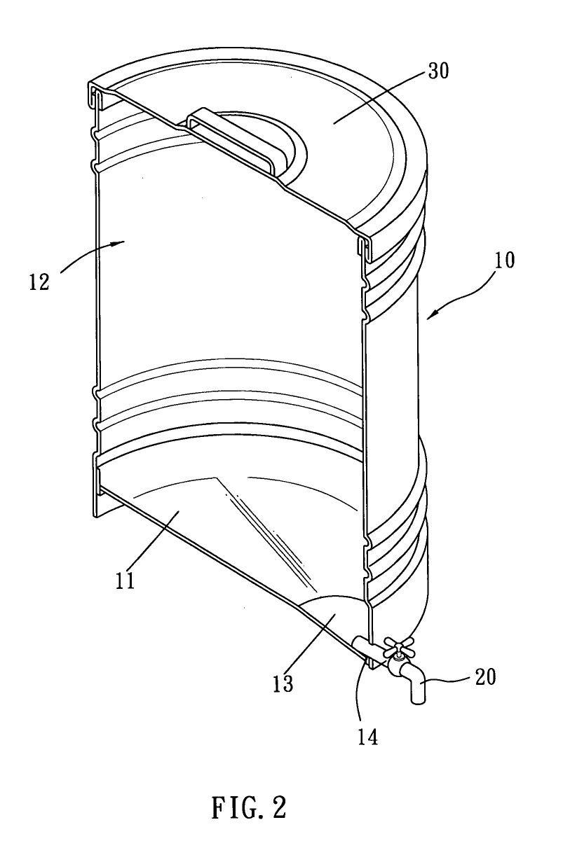

Referring to FIG. 2, a container structure of the invention includes a container body 10, a dispensing valve 20 and an upper cover 30. The container body 10 is made of a stainless material, which is circled to form a cylindrical sidewall. A baseplate 11 is tightly joined to a bottom end of the sidewall so that a chamber 12 for accommodating liquid, such as tea or drink, is formed between the container body 10 and the baseplate 11. An inclined guiding portion 13 is formed at a local position corresponding to the sidewall of the container body 10 and an outer edge of the baseplate 11. The inclined guiding portion 13 is inclined down in a direction toward the sidewall of the container body 10 so that the inclined guiding portion 13 at the end portion of the sidewall is located at a lowest point of the chamber 12. A mounting hole 14 is formed on the container body 10 at a position corresponding to the inclined guiding portion 13.

The dispensing valve 20 is mounted to the container body 10 and penetrates through the mounting hole 14 of the container body 10 by a welding or screwing structure, for example, so that the dispensing valve 20 communicates with the inclined guiding portion 13.

An inverse-U shaped handle is mounted on a top middle portion of the upper cover 30. The upper cover 30 covers the opening of the top of the container body 10 to achieve the dustproof and temperature-keeping effects.

According to the above-mentioned structure, it is obtained that the invention mainly has the inclined guiding portion 13 formed at the local position corresponding to the sidewall of the container body 10 and the outer edge of the baseplate 11 so that the remained liquid, such as the tea or drink, on the baseplate 11 can smoothly enter the inclined guiding portion 13, and then be drained out through the dispensing valve 20 communicating with the inclined guiding portion 13. Thus, it is possible to prevent the liquid from being wasted or remained, and it is unnecessary to tilt and shake the container body to drain the remained liquid out.

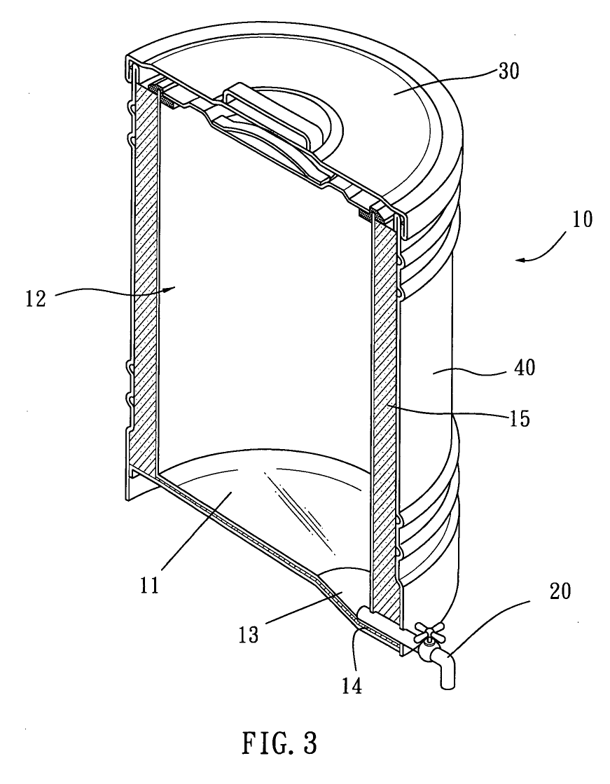

As shown in FIG. 3, a second embodiment of the invention is mainly applied to a heat insulating container structure, which includes a container body 10 made of a stainless steel material, which is circled to form a cylindrical sidewall. A bottom end of the container body 10 is tightly joined to a baseplate 11 with the same shape. An external container body 40 surrounds the sidewall with a heat insulating material 15 filled between the sidewall and the external container body 40 so that a temperature keeping container body having three layers is formed. A chamber 12 defined by the temperature keeping container body is for accommodating liquid, such as tea or drink, is formed between the container body 10 and the baseplate 11. Also an inclined guiding portion 13 is formed at a local position corresponding to the sidewall of the container body 10 and an outer edge of the baseplate 11. The inclined guiding portion 13 is inclined down in a direction toward the sidewall of the container body 10 so that the inclined guiding portion 13 at the end portion of the sidewall is located at a lowest point of the chamber 12. A mounting hole 14 is formed on the container body 10 at a position corresponding to the inclined guiding portion 13. A dispensing valve 20 is mounted to the container body 10 and penetrates through the mounting hole 14 of the container body 10 and the heat insulating material 15 so that the dispensing valve 20 communicates with the inclined guiding portion 13.

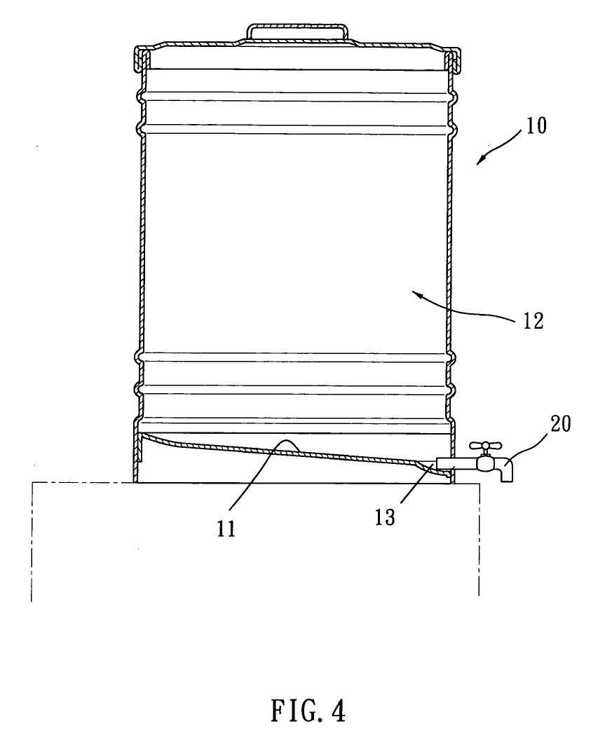

As shown in FIG. 4, the baseplate 11 of the container body 10 is an inclined baseplate 11 corresponding to the shape of the container body 10. Thus, a chamber 12 for accommodating the drink, such as tea or drink, may be formed between the container body 10 and the baseplate 11. An inclined guiding portion 13 is formed at a local position corresponding to the sidewall of the container body 10 and an outer edge of the baseplate 11. The inclined guiding portion 13 is inclined down in a direction toward the sidewall of the container body 10 so that the inclined guiding portion 13 at the end portion of the sidewall is located at a lowest point of the chamber 12. The baseplate 11 of the container body 10 in this embodiment crosses two opposite sides of the sidewall and is gradually inclined so that the tea or drink in the chamber 12 may be fully drained out through the dispensing valve 20. Thus, it is possible to avoid the conventional drawback that the drink or tea is remained in the container body 10 and thus wasted.

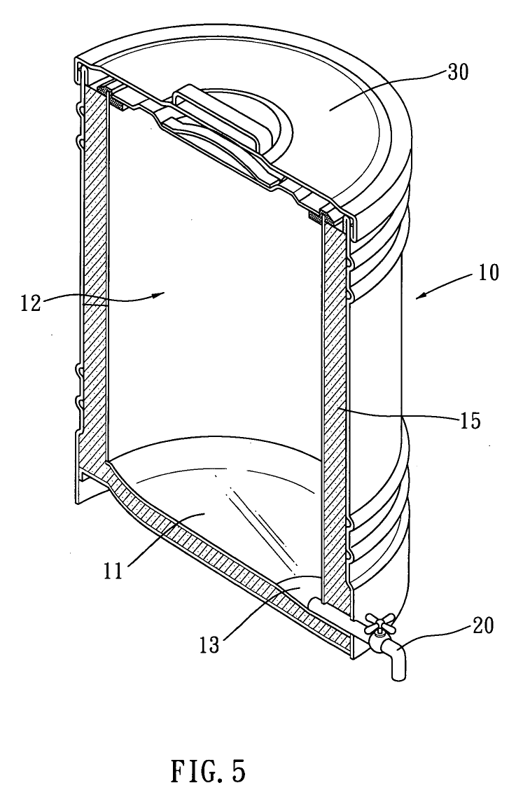

As shown in FIG. 5, the baseplate 11 of the heat insulating container is an inclined baseplate 11 corresponding to the shape of the container body 10 so that a chamber 12 for accommodating the liquid, such as tea or drink, may be formed between the container body 10 and the baseplate 11. An inclined guiding portion 13 is formed at a local position corresponding to the sidewall of the container body 10 and an outer edge of the baseplate 11. The inclined guiding portion 13 is inclined down in a direction toward the sidewall of the container body 10 so that the inclined guiding portion 13 at the end portion of the sidewall is located at a lowest point of the chamber 12. Thus, the tea or drink in the chamber 12 may be fully drained out to avoid the problem that the tea or drink is remained in the chamber 12.

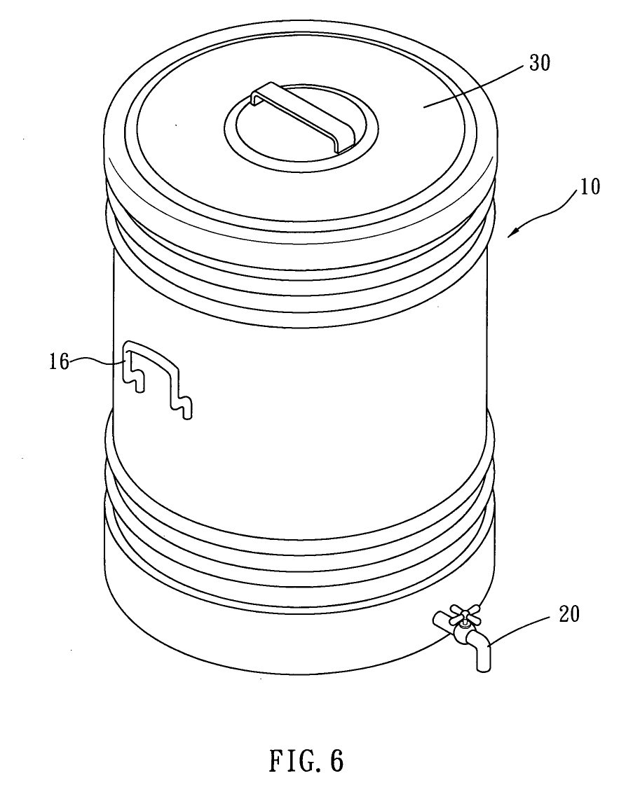

As shown in FIG. 6, inverse-U shaped handles 16 are mounted to two opposite sides of the circumference of the container body 10. The top end of the handle 16 extends slantingly outwards so that the palm of the hand can hold the handle 16 to move the container body 10.

In summary, the structures of the invention are novel and cannot be found in the prior art and have the advantages mentioned hereinabove. New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A container structure, comprising:
a container body having a bottom end tightly joined to a baseplate and a top end movably connected to an upper cover to form a chamber, wherein an inclined guiding portion is formed at a local position corresponding to a sidewall of the container body and an outer edge of the baseplate, and the inclined guiding portion is located at a lowest point of the chamber; and
a dispensing valve, which communicates with the inclined guiding portion and penetrates through the sidewall of the container body at a position corresponding to the inclined guiding portion.

2. The container structure according to claim 1, wherein an external container body is disposed outside the container body to surround the container body with a heat insulating material filled between the container body and the external container body.

3. The container structure according to claim 1, wherein the baseplate corresponding to the inclined guiding portion is inclined down in a direction toward the sidewall of the container body.

4. The container structure according to claim 1, wherein the baseplate is an inclined baseplate corresponding to a shape of the container body.
